(19) United States
(12) Patent Application Publication
(10) Pub. No.: US 2010/0007648 A1
(43) Pub. Date: Jan. 14, 2010

(54) DRIVING APPARATUS AND DISPLAY DEVICE INCLUDING THE SAME

(75) Inventors: Hyoung-Sik NAM, Incheon (KR); Seon-Ki KIM, Ahnyang-si (KR); Byung-Hyuk SHIN, Seoul (KR); Jae-Ho OH, Seoul (KR); Kyung-Woo KIM, Cheonan-si (KR)

Correspondence Address: CANTOR COLBURN, LLP, 20 Church Street, 22nd Floor, Hartford, CT, 06103, US

(73) Assignee: Ssmsung Electronics Co., Ltd., Suwon-si (KR)

(21) Appl. No.: 12/171,690

(22) Filed: Jul. 11, 2008

(51) Int. Cl. G06F 3/038

(52) U.S. Cl. 345/213

(57) ABSTRACT

The present invention relates to a driving device for a liquid crystal display and a driving method thereof. A signal controller of the driving device generates a data signal according to an input image signal input to the display device, generates a clock signal according to the input control signal, and generates a differential pair image signal by modulating the clock signal to the data signal. Here, a data signal period of the differential pair image signal and a clock signal period are converted with a different level and are output. A data driver of the driving device receives the differential pair image signal, divides the data signal and the clock signal from the differential pair image signal, and generates a data voltage by sampling a data signal by using the clock signal.

### BACKGROUND OF THE INVENTION

(a) Field of the Invention

The present invention relates to a driving apparatus for a display device and a display device including the same.

(b) Description of the Related Art

Recently, flat panel displays such as an organic light emitting device (OLED), a plasma display panel (PDP), and a liquid crystal display (LCD) have been actively developed as substitutes for the cathode ray tube (CRT) which is heavy and large.

A PDP is a device that displays characters or images using plasma generated by a gas-discharge, and an OLED is a device that displays characters or images using electroluminescence of a specific organic material or high molecules. An LCD displays desired images by applying an electric field to a liquid crystal (LC) layer interposed between two panels and regulating the strength of the electric field to adjust the transmittance of light passing through the LC layer.

Among such flat panel displays, as examples, the LCD and the OLED each include a display panel provided with pixels including switching elements and display signal lines, a gate driver for providing gate signals to gate lines among the display signal lines to turn on/off the switching elements of the pixels, a gray voltage generator for generating a plurality of gray voltages, a data driver for selecting a voltage corresponding to image data as a data voltage from the gray voltages and applying the data voltage to a data line among the display signal lines, and a signal controller for controlling the above elements.

Each driver is supplied with necessary predetermined voltages and converts them into various voltages to drive the display device. For example, the gate driver receives a gate-on voltage and a gate-off voltage and alternatively applies them to the gate line as a gate signal, and a gray voltage generator receives a uniform reference voltage and divides it through a plurality of resistors to provide divided voltages to a data driver.

It is necessary for the driving apparatus of the display device to use a data transmitting technique with high speed in the driving apparatus to realize a large size and high resolution. In particular, to transmit the data signals between the signal controller and the data driver with high speed, an intra-panel-interface of a point-to-point method is used. Generally, the data driver includes a plurality of source drivers, and each source driver is connected to the signal controller through an independent signal line in the intra-panel-interface of the point-to-point method. Accordingly, disconformities of the impedances are decreased compared with the conventional multi-drop method in which a plurality of source drivers are connected through one signal line such that electromagnetic interference may be reduced. Also, if an embedded clock with which clock signals are inserted between the data signals by applying a multi-level signaling technique is used, an additional signal line to transmit the clock signals is not necessary. Also, the data signals and the clock signals are separately transmitted such that problems due to skew generated between the data signals and the clock signals may be prevented.

The above information disclosed in this Background section is only for enhancement of understanding of the background of the invention and therefore it may contain information that does not form the prior art that is already known in this country to a person of ordinary skill in the art.

### SUMMARY OF THE INVENTION

A technical object of the present invention is to provide a driving apparatus of a liquid crystal display and a driving method to transmit data signals without additional signal lines.

A driving device for a display device displaying images according to an input image signal and an input control signal according to an exemplary embodiment of the present invention includes a signal controller generating a data signal according to the input image signal, generating a clock signal according to the input control signal, generating a differential pair image signal by modulating the clock signal to the data signal, and respectively converting the data signal period and the clock signal period of the differential pair image signal into a different level. The signal controller includes a transmitter receiving the data signal and the clock signal, generating a modulation signal by inserting the clock signal to the data signal with a predetermined interval, converting the modulation signal into the differential pair image signal having the different level respectively corresponding to the data signal period and the clock signal period. The transmitter includes a serial unit receiving the data signal and aligning it in series, a multiplex unit inserting the clock signal to the arranged data signal in series to generate the modulation signal, an image signal generator receiving the modulation signal and converting the modulation signal into the differential pair image signal having the different level corresponding to the data signal period and the clock signal period, and a transmission controller receiving the information for the data signal and clock signal and controlling the position for inserting the clock signal to the data signal according to the predetermined interval. A data driver receiving the differential pair image signal, dividing the data signal and the clock signal from the differential pair image signal, and sampling the data signal by using the clock signal to generate a data voltage may be included. The differential pair image signal of the data signal period may be less than the differential pair image signal of the clock signal period. The differential pair image signal may further include a data control signal for controlling the operation of the data. The data driver may recover the clock signal with a frequency corresponding to a frequency of the data signal, sample the data signal by using the recovered clock signal to generate a digital data signal, and generate a data voltage corresponding to the digital data signal.

A driving method for a display device displaying images according to the input image signal and input control signal according to an exemplary embodiment of the present invention includes modulating by inserting the clock signal generated according to the input control signal to a data signal corresponding to the input image signal with the predetermined interval, and converting the modulated signal into a differential pair image signal by discriminating the different level according to the period corresponding to the data signal and the period corresponding to the clock signal. The driving method may further include generating a data voltage corresponding to the input image signal by receiving the differential pair image signal, and the generating of the data voltage may include recovering the clock signal with the frequency corresponding to the frequency of the data signal, generating a digital data signal by sampling the data signal by using the recovered clock signal, and selecting a data voltage corresponding to the digital data signal among a plurality of gray voltages. The modulating may be executed by further including a data control signal to the data signal and clock signal, and the data control signal is a signal for controlling the generating the data voltage.

### BRIEF DESCRIPTION OF THE DRAWINGS

The accompanying drawings briefly described below illustrate exemplary embodiments of the present invention and, together with the description, serve to explain the principles of the present invention.

FIG. 1 is a block diagram of a liquid crystal display according to an exemplary embodiment of the present invention.

FIG. 2 is an equivalent circuit diagram of one pixel in the liquid crystal display according to an exemplary embodiment of the present invention.

FIG. 3 is a view showing a differential pair image signal generated in a signal controller according to an exemplary embodiment of the present invention.

FIG. 4 is a block diagram showing a connection structure between a signal controller and a plurality of source drivers according to an exemplary embodiment of the present invention.

FIG. 5 is a view showing a signal controller according to an exemplary embodiment of the present invention.

FIG. 6 is a view showing a transmitter according to an exemplary embodiment of the present invention.

FIG. 7 is a view showing a source driver according to an exemplary embodiment of the present invention.

### DESCRIPTION OF PRIMARY REFERENCE NUMERALS

3: liquid crystal layer 100: lower panel

191: pixel electrode 200: upper panel

230: color filter 270: common electrode

300: liquid crystal panel assembly 400: gate driver

500: data driver 500_{—}k: source driver

600: signal controller 610:receiver

620: gamma corrector 630: overdriving unit

640: timing controller 650: transmitter

800: gray voltage generator

R,G,B: input image data DE: data enable signal

MCLK: main clock signal Hsync: horizontal synchronizing signal

Vsync: vertical synchronization signal CONT1: gate control signal

CONT2: data control signal DAS_k: differential pair image signal

Clc: liquid crystal capacitor Cst: storage capacitor

Q: switching element

### DETAILED DESCRIPTION OF THE EMBODIMENTS

The present invention will be described more fully hereinafter with reference to the accompanying drawings, in which exemplary embodiments of the invention are shown.

In the drawings, the thickness of layers, films, panels, regions, etc., are exaggerated for clarity. Like reference numerals designate like elements throughout the specification. It will be understood that when an element, such as a layer, film, region, or substrate is referred to as being “on” another element, it can be directly on the other element or intervening elements may also be present. In contrast, when an element is referred to as being “directly on” another element, there are no intervening elements present.

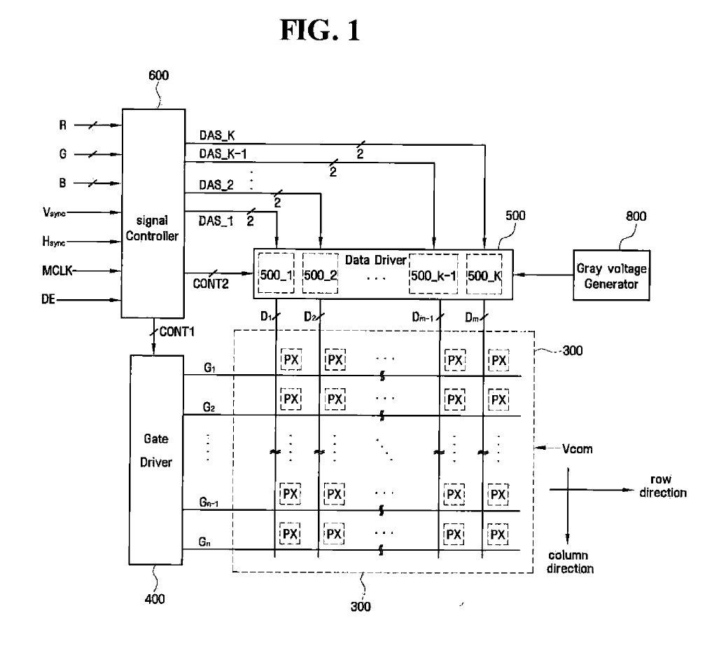

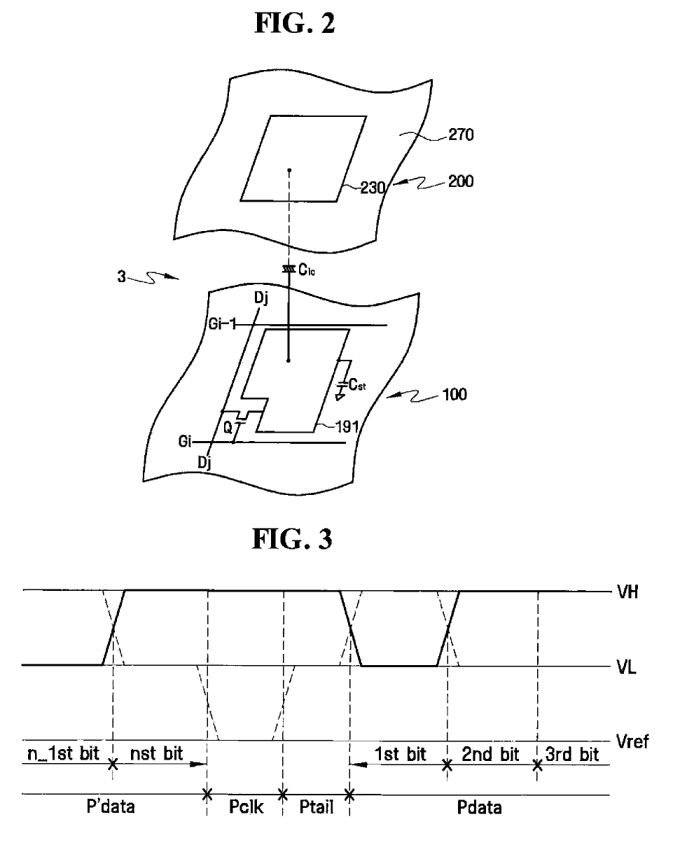

Firstly, a liquid crystal display according to an exemplary embodiment of the present invention will be described in detail with reference to FIG. 1 and FIG. 2.

FIG. 1 is a block diagram of a liquid crystal display according to an exemplary embodiment of the present invention, and FIG. 2 is an equivalent circuit diagram of one pixel in the liquid crystal display according to an exemplary embodiment of the present invention.

Referring to FIG. 1, a liquid crystal display according to an exemplary embodiment of the present invention includes a liquid crystal panel assembly 300, a gate driver 400, a data driver 500, a gray voltage generator 800, and a signal controller 600.

Referring to FIG. 1, in an equivalent circuit, the liquid crystal panel assembly 300 includes a plurality of signal lines G1-Gn and D1-Dm, and a plurality of pixels PX that are connected to the plurality of signal lines G1-Gn and D1-Dm and are arranged in an approximate matrix shape. The signal lines D1-Dm includes a plurality of data lines for delivering data signals, respectively. Meanwhile, referring to a structure shown in FIG. 2, the liquid crystal panel assembly 300 includes lower and upper display panels 100 and 200 that face each other, and a liquid crystal layer 3 that is interposed between the lower and upper display panels 100 and 200.

The signal lines G1 to Gn include a plurality of gate lines G1 to Gn for delivering gate signals (also referred to as scan signals). The gate lines G1 to Gn extend in an approximate row direction and are almost parallel to each other, and the data lines D1 to Dm extend in a column direction and are almost parallel to each other.

Each pixel, for example a pixel PX includes a switching device Q connected to one of the gate lines and one of the data lines, a liquid crystal capacitor Clc that is connected to the switching device Q, and a storage capacitor Cst. The storage capacitor Cst may be omitted if necessary.

The switching element Q is a three-terminal element included in the lower display panel 100, such as a thin film transistor. In the switching device Q, a control terminal is connected to one of the gate lines, an input terminal is connected to one of the data lines, and an output terminal is connected to the liquid crystal capacitor Clc and the storage capacitor Cst

The liquid crystal capacitor Clc has a pixel electrode 191 of the lower display panel 100 and a common electrode 270 of the upper display panel as two terminals, and the liquid crystal layer 3 between the two electrodes 191 and 270 functions as a dielectric. The pixel electrode 191 is connected to the switching device Q. The common electrode 270 is formed on the whole surface of the upper display panel 200, and a common voltage Vcom is applied to the common electrode 270. The common electrode 270 may be included in the lower display panel 100, different than what is illustrated in FIG. 2, and in that case, at least one of the two electrodes 191 and 270 may be formed in a shape of a line or a bar.

The storage capacitor Cst that serves as an auxiliary to the liquid crystal capacitor Clc is formed as a separate signal line (not shown) provided on the lower panel 100 and the pixel electrode 191 overlapping it with an insulator interposed therebetween, and a predetermined voltage such as the common voltage Vcom or the like is applied to the separate signal line. Also, the storage capacitor Cst can be formed as the pixel electrode 191 overlaps the immediate previous gate line G(i−1) by the medium of the insulator.

Meanwhile, in order to realize a color display, each pixel PX specifically displays one of the primary colors (spatial division), or the pixels PX alternately display the primary colors over time (temporal division), which causes the primary colors to be spatially or temporally synthesized, thereby displaying a desired color. An example of the primary colors is three primary colors including red, green, and blue. FIG. 2 is an example of spatial division. As shown in the figure, each of the pixels PX includes a color filter 230 representing one of the primary colors and is disposed in a region of the upper display panel 200 corresponding to a pixel electrode 191. Unlike FIG. 2, the color filter 230 in other embodiments of the invention may be formed above or below the pixel electrode 191 of the lower display panel 100.

At least one polarizer (not shown) for polarizing light is attached to an outer surface of the liquid crystal panel assembly 300.

Referring to FIG. 2 again, the gray voltage generator 800 generates all gray voltages or a limited number of gray voltages (hereinafter referred to as “reference gray voltages”) related to the transmittance of the pixels PX. The (reference) gray voltages may include gray voltages that have a positive value and gray voltages that have a negative value with respect to the common voltage Vcom.

The gate driver 400 is connected to the gate lines G1-Gn of the display panel assembly 300 and synthesizes a gate-on voltage Von and a gate-off voltage Voff to generate gate signals, which are applied to the gate lines G1-Gn.

The data driver 500 is connected to the data lines D1-Dm of the display panel assembly 300, and selects gray voltages supplied from the gray voltage generator 800 and then applies the selected gray voltages to the data lines D1-Dm as data voltages. However, in the case when the gray voltage generator 800 supplies only a limited number of reference gray voltages rather than supplying all gray voltages, the data driver 500 divides the reference gray voltages to generate desired data voltages. The data driver 500 according to an exemplary embodiment of the present invention includes a plurality of source drivers 500_{—}k, and each source driver 500_{—}k directly receives a differential pair of image signals DAS_k from the signal controller. The source drivers 500_{—}k are connected to the corresponding data lines, and apply data voltages to the corresponding data lines. The source drivers 500_{—}k apply the data voltages to the data lines according to a data control signal CONT2 that is transmitted to the source drivers 500_{—}k from the signal controller 600, and accordingly the data voltages may be transmitted to the pixels PX.

Each of the driving circuits 400, 500, 600, and 800 may be directly mounted as at least one integrated circuit (IC) chip on the panel assembly 300 or on a flexible printed circuit film (not shown) in a tape carrier package (TCP) type, which are attached to the LC panel assembly 300, or may be mounted on a separated printed circuit board (not shown). Alternatively, the driving circuits 400, 500, 600, and 800 may be integrated with the panel assembly 300 along with the signal lines G1-Gn and D1-Dm and the TFT switching elements Q. Further, the driving circuits 400, 500, 600, and 800 may be integrated as a single chip. In this case, at least one of them or at least one circuit device constituting them may be located outside the single chip.

Now, the operation of the above-described LCD will be explained in detail.

The signal controller 600 is supplied with input image signals R, G, and B and input control signals for controlling the display thereof from an external graphics controller (not shown). The input image signals R, G, and B contain luminance information of each pixel (PX). The luminance has a predetermined number of grays, such as 1024 (=2¹⁰), 256 (=2⁸), or 64 (=2⁶). The input image signals R, G, and B and the input control signals according to an exemplary embodiment of the present invention may be signals following low voltage differential signaling (hereinafter referred to as “LVDS”). The input control signals include, for example, a vertical synchronization signal Vsync, a horizontal synchronization signal Hsync, a main clock signal MCLK, and a data enable signal DE.

The signal controller 600 processes the input image signals R, G, and B in such a way to be suitable for the operating conditions of the liquid crystal panel assembly 300 based on the input image signals R, G, and B of the LVDS mode and the input control signal. The signal controller 600 generates a plurality of differential pair image signal DAS_k, a gate control signal CONT1, a data control signal CONT2, and so on, and it sends the gate control signal CONT1 to the gate driver 400 and the data control signal CONT2 and processed image signals DAS_k to the data driver 500. Each of the differential pair image signals DAS_k according to an exemplary embodiment of the present invention are generated according to a multi-level signaling mode in which clock signals CLK, having different magnitudes from the data signals DATA, are inserted between the data signals DATA that ate used for the image data. The clock signal CLK is a signal having a predetermined frequency for sampling the data signals DATA input to the data driver 500 as a receiving terminal, and the clock signal CLK may have the same frequency as the data signals DATA, or a lower frequency than the data signals DATA. Also, the data control signal CONT2 is transmitted to the data driver 500 through different signal lines in FIG. 1, but the present invention is not limited by this and a plurality of differential pair image signals DAS_k may be transmitted to the data driver 500 by the same signal line along with the data control signal CONT2. The image signals according to an exemplary embodiment of the present invention will be explained in detail with reference to FIG. 3.

The gate control signal CONT1 includes a scan start signal STV for indicating scan start, and at least one clock signal for controlling an output period of the gate-on voltage Von. The gate control signal CONT1 may further include an output enable signal OE for limiting a time duration of the gate-on voltage Von.

The data control signal CONT2 includes a horizontal synchronization start signal STH for indicating initiation of data transmission of the differential pair image signals DAS_k to the data driver 500 for a row (group) of pixels PX, a load signal LOAD for requesting the application of analog data voltages to the data lines D1 to Dm, and a data clock signal HCLK. The data control signal CONT2 may further include a reverse signal RVS for inverting voltage polarity of the data signal with respect to the common voltage Vcom (hereinafter, “voltage polarity of the data signal with respect to the common voltage” is abbreviated to “polarity of the data signal”).

The data driver 500 includes a plurality of source drivers 500_{—}k, and each source driver 500_{—}k receives a corresponding image signal among the image signals DAS_k. The source drivers 500_{—}k separate the clock signals CLK from the received differential pair image signals DAS_k to restore the clock signal CLK to the predetermined frequency or generate a plurality of multi-phase clock signals by using the clock signal CLK. The source drivers 500_{—}k sample the data signals DATA by using the restored clock signals CLK or the generated clock signals CLK to generate the digital image signals DAT. Here, the predetermined frequency to which the clock signal CLK is restored and the frequency of the generated clock signals CLK may be the same frequency as the data signal DATA or a frequency corresponding to half of the data signal DATA. When the restored clock signal CLK has the same frequency as the data signal DATA, the data signal DATA is sampled in synchronization with the rising edge timing of the restored clock signal, and when the clock signal CLK has the half frequency of the data signal DATA, the data signal DATA is sampled in synchronization with the rising edge timing and falling edge timing of the clock signal CLK. The data driver 500 selects a grayscale voltage corresponding to each digital image signal DAT to generate the digital image signals DAT as analog data signals. Thereafter the data driver 500 applies the generated analog data signals to corresponding data lines D1 to Dm.

The gate driver 400 applies a gate-on voltage Von to the gate lines G1 to Gn according to the gate control signal CONT1 transmitted from the signal controller 600 to turn on switching devices Q connected to the gate lines G1 to Gn, and then the data signals applied to the data lines D₁ to Dₘ are applied to corresponding pixels PX through the turned-on switching devices Q.

A difference between a voltage of the data signal applied to the pixels PX and the common voltage Vcom appears as a charged voltage of the liquid crystal capacitor Clc, that is, a pixel voltage. Alignment of the liquid crystal molecules varies according to the magnitude of the pixel voltage to change the polarization of light passing through the liquid crystal layer 3. The transmittance of light is changed by a polarizer attached to the liquid crystal panel assembly 300 according to the change in the polarization such that the pixels PX display the luminance corresponding to the grays of the digital image signals DAT.

In units of one horizontal period, which may be written as “1H” and is the same as one period of the horizontal synchronization signal Hsync and the data enable signal DE, the aforementioned operations are repeatedly performed to sequentially apply the gate-on voltages Von to all the gate lines G₁ to Gₙ, so that the data signals are applied to all the pixels PX. As a result, one frame of the image is displayed.

When one frame ends, the next frame starts, and a state of the reverse signal RVS applied to the data driver 500 is controlled so that the polarity of the data signal applied to each of the pixels is opposite to the polarity in the previous frame (frame inversion). At this time, even in one frame, according to the characteristics of the reverse signals RVS, the polarity of the data signal flowing through one data line may be inverted (row inversion and dot inversion). In addition, the polarities of the data signals applied to one pixel row may be different from each other (column inversion and dot inversion).

FIG. 3 is a view showing one differential pair image signal DAS_q among the differential pair image signals DAS_k generated in a signal controller 600 according to an exemplary embodiment of the present invention. The image signal DAS_q is applied to a corresponding source driver 500_{—}q among a plurality of source drivers 500_{—}k of the data driver 500. The signal controller 600 according to an exemplary embodiment of the present invention generates the differential pair image signal DAS_q by inserting the clock signal CLK in the data signals DATA representing a plurality of bits corresponding to one pixel. Here, the differential pair image signal DAS_q according to an exemplary embodiment of the present invention includes a data signal period Pdata representing the data signals DATA made of a plurality of n bits as a differential pair signals, a clock signal period Pclk representing the clock signal CLK as a differential pair signal, and a clock tail period Ptail representing a clock tail signal adding the same bits as the n-th bits of the signals DATA as a differential pair signal. In FIG. 3, the data signal period P′data is a data signal of a different pixel connected to a different data line from the data line transmitting the data signal DATA among a plurality of data lines connected to the source driver 500_{—}q. One pixel is a unit including three sub-pixels representing R, G, and B colors, and if the gray of each color is 8 bits, the differential pair image signal DAS_q represents the data of 26 total bits including 24 bits representing the gray bits of three colors R, G, and B, 1 bit represents the clock signal CLK, and 1 bit represents the clock tail signal CLKt. That is, the differential pair image signal DAS_q is a differential pair signal corresponding to the total of 26 bits. This is an exemplary embodiment of the present invention and the present invention is not limited by it. Unlike FIG. 3, in other embodiments of the invention the clock signal CLK may be inserted between each bit of the data signals DATA one by one.

The differential pair image signal DAS_q includes a positive signal Vinp and a negative signal Vinn. The differential pair image signal DAS_q represents the digital data by using the positive signal Vinp and the negative signal Vinn forming the differential pair signal.

During the data signal period, the positive signal Vinp is one of a high level voltage VH or a low level voltage VL, and Vinn is the opposite voltage. The high level voltage VH is higher than the low level voltage VL. If the positive signal Vinp is the high level voltage VH and the negative signal Vinn is a low level voltage VL, which means that the difference between the positive signal Vinp and the negative signal Vinn is positive, the image signal DAS_q represents the digital data “1”, and if the positive signal Vinp is the low level voltage VL and the negative signal Vinn is the high level voltage VH, which means that the difference between the positive signal Vinp and the negative signal Vinm is negative, the differential pair image signal DAS_q presents the digital data “0”. The positive signal Vinp of the differential pair signal corresponding to the 1st bit of the data signals DATA is less than the negative signal Vinn of the differential pair signal. Accordingly, the 1st bit corresponds to the digital data “0”. The 2nd bit corresponds to the digital data “1”, because the positive signal Vinp is greater than the negative signal Vinn.

During the clock signal period, the positive signal Vinp is one of a high level voltage VH or a reference voltage Vref, and Vinn is the opposite voltage. The reference voltage Vref is lower than the low level voltage VL. If the positive signal Vinp is the high level voltage VH and the negative signal Vinn is the reference voltage Vref, which means that the difference between the positive signal Vinp and the negative signal Vinn is positive, the image signal DAS_q represents the digital data “1”, and if the positive signal Vinp is the reference voltage Vref and the negative signal Vinn is the high level voltage VH, which means that the difference between the positive signal Vinp and the negative signal Vinm is negative, the differential pair image signal DAS_q presents the digital data “0”. The positive signal Vinp of the differential pair signal corresponding to the clock signal CLK is greater than the negative signal Vinn of the differential pair signal. Accordingly, the clock signal CLK corresponds to the digital data “1”.

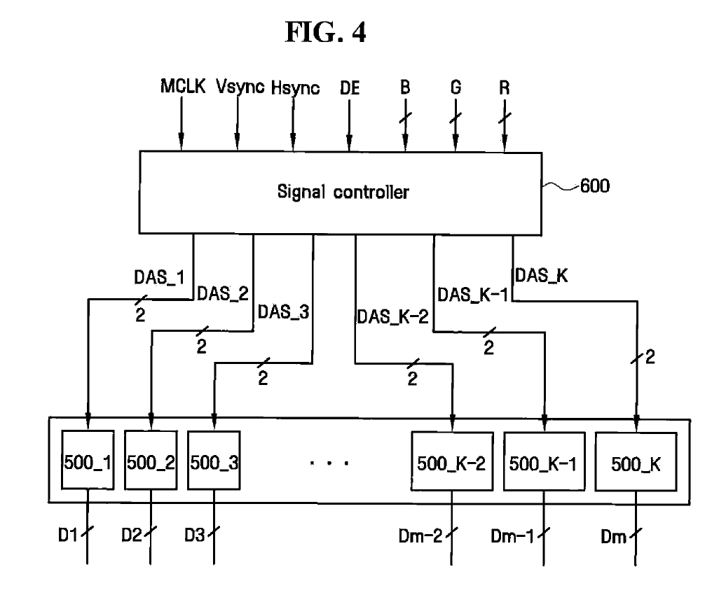

FIG. 4 is a block diagram showing a connection structure between a signal controller 600 and a plurality of source drivers 500_{—}k according to an exemplary embodiment of the present invention

Each source driver 500_{—}k respectively receives the differential pair image signals DAS_k from the signal controller 600, and converts them into a plurality of data voltages to transmit the data voltages to a plurality of data lines D1-Dm.

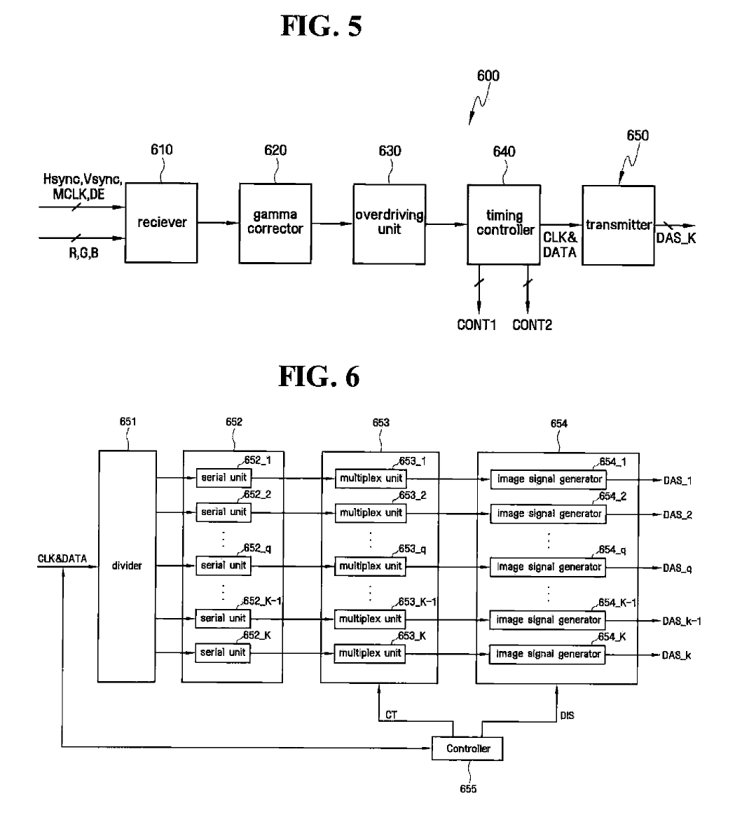

FIG. 5 is a view showing a signal controller 600 according to an exemplary embodiment of the present invention.

As shown in FIG. 5, the signal controller 600 includes a receiver 610, a gamma corrector 620, an overdriving unit 630, a timing controller 640, and a transmitter 650.

The receiver 610 receives input image signals R, G, and B and input control signals Hsync, Vsync, MCLK, and DE of an LVDS mode from an external graphics controller to generate image data according to the input image signals and a synchronization control signal according to the input control signals for displaying the images. The synchronization control signal includes a clock signal CLK.

The gamma corrector 620 executes gamma correction to adjust the image data to the liquid crystal display. The gamma corrected image data is transmitted to the overdriving unit 630.

The overdriving unit 630 compares the frame data with the present frame data directly before receiving the gamma corrected image data. If a gray change between the frame data is larger than a predetermined value, the present frame data is amplified to compensate a response speed. A liquid crystal layer included in the display device of the liquid crystal display has a stow response speed, and when the gray change between the previous frame and the present frame is large, it is difficult to display the correct gray of the present frame data. The overdriving unit 630 is an element to improve this.

The timing controller 640 generates the gate control signal CONT1, the data control signal CONT2, and the clock signal CLK by using the synchronization control signal, and controls the alignment of the image data according to the synchronization control signal to transmit the data signal DATA and the clock signal CLK to the transmitter 650. In detail, the timing controller 640 generates the data signal DATA and the clock signal CLK transmitted to the source drivers 500_{—}k to transmit to the transmitter 650 in series.

The transmitter 650 divides the data signals DATA and the clock signal CLK, and generates a plurality of image signals DAS1-k described in FIG. 3 to transmit to the source drivers 500_{—}k.

The transmitter 650 will be described in detail with reference to FIG. 6.

FIG. 6 is a view showing a transmitter 650 according to an exemplary embodiment of the present invention.

As shown in FIG. 6, the transmitter 650 includes a divider 651, a serial circuit 652, a multiplex circuit 653, an image signal generating circuit 654, and a transmission controller 655. The serial circuit includes a plurality of serial units 652_{—}k, the multiplex circuit 653 includes a plurality of multiplex units 653_{—}k, and the image signal generating circuit 654 includes a plurality of image signal generators 654_{—}k.

The divider 651 divides the data signals DATA and the clock signal CLK, which are received in series, and transmits them to a plurality of serial units 652_{—}k, respectively.

Each of the serial units 652_{—}k converts the data signals DATA and the clock signal CLK, and transmits them to the multiplex units 653_{—}k.

Each of the multiplex units 653_{—}k modulates the data signals DATA and the clock signal CLK according to the control of the transmission controller 655 to respectively transmit them to the image signal generators 654_{—}k. For example, the multiplex units 653_{—}q inserts the clock signal CLK of 1 bit and the clock trail signal CLKt of 1 bit between the data signal DATA of one pixel and another data signal DATA of the neighboring pixel.

This generated modulation signal is transmitted to the image signal generator 654_{—}q. The other multiplex unit of the multiplex circuit 653 is operated the same way.

Each image signal generator 654_{—}k converts the modulation signal that is input from the corresponding multiplex unit 653_{—}k into the image signal DAS_k to respectively transmit to the source driver 500_{—}k. As described above in FIG. 3, the image signal generator 654_{—}q generates the image signal DAS_q that is made of the differential pair. The transmission controller 655 controls the multiplex unit 653_{—}k to modulate the data signal and the clock signal according to the predetermined information, and controls the image data generators 654_{—}k to amplify the data signal DATA and the clock signal CLK into the differential pair signal having the different level and outputting it. In detail, the transmission controller 655 transmits the modulation order signal CT inserting the clock signal CLK with the predetermined period unit in the data signals DATA according to the predetermined information to the multiplex units 653_{—}k. Each multiplex unit 653_{—}k inserts the clock signal CLK between the data signals DATA according to the modulation order signal CT, and respectively transmits them to the image signal generators 654_{—}k. The predetermined information may be data previous stored to a data base (not shown) of a liquid crystal display, and may be included in an additional data base to store the predetermined information by the controller 655.

The transmission controller 655 controls the image signal generators 654_{—}k for the clock signal and the data signal to be a differential pair signal having the different level according to the predetermined information. In detail, the transmission controller 655 transmits the discrimination signal DIS to the image signal generator 654_{—}k to inform whether the modulation signal input to the image signal generator 654_{—}k is the data signal DATA or the clock signal CLK. The image signal generator 654_{—}k generates image signals by respectively converting the differential pair signal corresponding to the data signal DATA and the clock signal CLK according to the discrimination signal DIS into the different level. In this way, the image signal generator 654_{—}k receives the modulation signal that the clock signal CLK is inserted in the data signal DATA, amplifies the data signal DATA and the clock signal CLK into the differential pair signal of the different level according to instructions received from the transmission controller 655, and generates the image signal DAS_q for the differential pair signal of the data signal DATA to have the same level as the differential pair level signal of the clock signal CLK upon the level conversion of the data signal DATA.

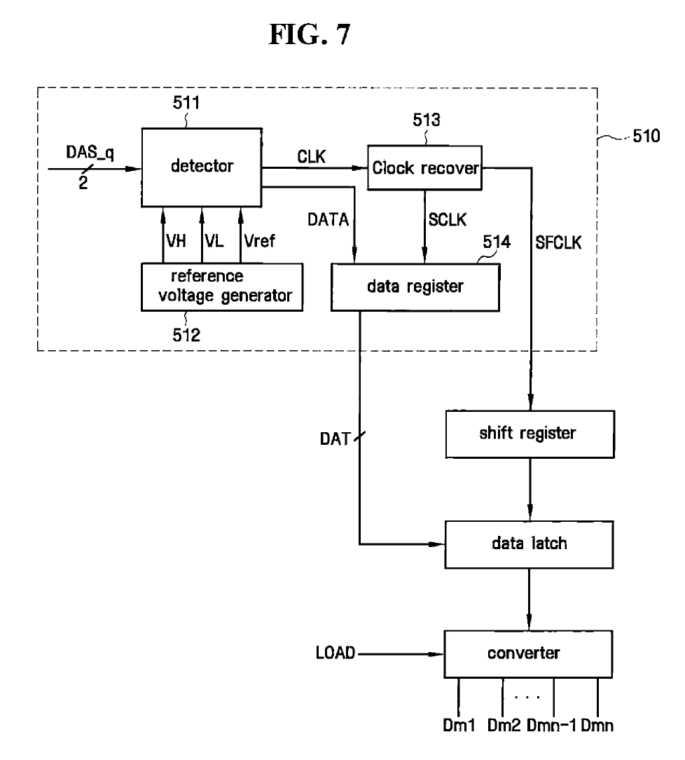

Next, the source drivers will be described with reference to FIG. 7.

FIG. 7 is a view showing one source driver 500_{—}q among a plurality of source drivers 500_{—}k according to an exemplary embodiment of the present invention. The other source drivers also have the same structure as the source driver 500_{—}q.

The source driver 500_{—}q includes a signal receiver 510, a shift register 520, a data latch 530, and a converter 540. The source driver 500_{—}q is connected to a plurality of data lines Dm1-Dmn.

The receiver 510 includes a detector 511, a reference voltage generator 512, a clock recover 513 and a data register 514.

The reference voltage generator 512 generates a high level voltage VH, a low level voltage VL, and a reference voltage Vref for the detector 511 to discriminate the data signal DATA and the clock signal CLK from the differential pair image signal DAS_q. The high level voltage VH is more than the low level voltage VL. The reference voltage Vref is less than the low level voltage VL of the differential pair signal.

The detector 511 receives the differential pair image signal DAS_q and detects the voltage level of the image signal DAS_q to divide the clock signal CLK and the data signal DATA by using the high level voltage VH, the low level voltage VL, and the reference voltage Vref. Referring to FIG. 3, a signal shown in FIG. 3 is input to the source driver 500_{—}q. As shown in FIG. 3, the signal of which the difference between the positive signal Vinp and the negative signal Vinn of the differential pair image signal DAS_q received by the detector 511 is substantially the same as the differences between the high level voltage VH and the low level voltage VL is determined to be the data signal DATA, and the signal of which the difference between the positive signal Vinp and the negative signal Vinn of the differential pair image signal DAS_q received by the detector 511 is substantially same as the differences between the high level voltage VH and the reference voltage Vref is determined to be the clock signal CLK. The detector 511 divides the data signal DATA and the clock signal CLK and transmits them to the data latch 540 and the clock recovery unit 513, respectively.

The clock recovery unit 513 recovers the received clock signal CLK with the same frequency as the frequency of the data signal DATA to generate the sampling clock signal SCLK for sampling the data signal DATA. The data register 514 samples the data signal DATA in synchronization with the rising edge point of the sampling clock signal SCLK, and may generate the digital data DAT. Alternatively, the data register 514 generates a sampling clock signal SCLK having a frequency corresponding to half of the frequency of the data signal DATA, and samples the data signal DATA at the rising and falling points of the sampling clock signal SCLK to generate the digital data DAT. Also, the clock recovery unit 513 generates the signal for the data treatment in the source driver 500_{—}q. In detail, the clock signal CLK is converted according to the data control signal CONT2 that is directly transmitted from the signal controller 600 or is transmitted along with the image signal, and a clock signal SFCLK having a predetermined frequency is generated.

The shift register 520 enables the data latch 530 according to the clock signal SFCLK and when enabled, the data latch 530 latches the digital data DAT transmitted from the data register 514. Also, the data latch 530 holds the latched data when the data latch 530 is disabled by the shift register 520. If the digital data DAT that will be outputted to the pixels PX of the one row connected to the data lines Dm1-Dmn connected to the source driver 500_{—}q are all stored, the latched digital data are simultaneously transmitted to the converter 540 in parallel.

The converter 540 selects the gray voltage according to the received digital data and converts the digital data into the analog data voltage, and then simultaneously outputs the plurality of analog data voltages to the plurality of data lines Dm1-Dmn according to a load signal LOAD.

These operations are respectively generated in the plurality of source drivers 500_{—}k, because each source driver 500_{—}k receives the same data driving control signal for controlling the synchronization, and the points at which the data voltages are transmitted to the plurality of pixels of one row from each source driver 500_{—}k are the same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Accordingly, in the driving device of the display device and the driving method thereof according to an exemplary embodiment of the present invention, the data signals between the signal controller and the source driver may be transmitted without distortion.

What is claimed is:

1. A driving device for a display device displaying images according to an input image signal and an input control signal, comprising:
a signal controller generating a data signal according to the input image signal, generating a clock signal according to the input control signal, generating a differential pair image signal including a positive signal and a negative signal by modulating the clock signal to the data signal, and respectively converting the differential pair image signal of the data signal period and the clock signal period into different levels,
wherein
during the data signal period, a voltage difference between the positive signal and the negative signal is substantially the same as a voltage difference between a high level voltage and a low level voltage, and
during the clock signal period, a voltage difference between the positive signal and the negative signal is substantially the same as a voltage difference between the high level voltage and a reference voltage.

2. The driving device of claim 1, wherein the high level voltage is higher than the low level voltage and the reference voltage is lower than low level voltage.

3. The driving device of claim 2, wherein
the differential pair image signal represents the digital data “1” when the difference between the positive signal and the negative signal is positive, and
the differential pair image signal represents the digital data “0” when the difference between the positive signal and the negative signal is negative.

4. The driving device of claim 1, wherein during the data signal period, the positive signal is one of the high level voltage or the low level voltage, and the negative signal is the opposite voltage.

5. The driving device of claim 1, wherein during the clock signal period, the positive signal is one of the high level voltage or the reference voltage, and the negative signal is the opposite voltage.

6. The driving device of claim 1, wherein
the signal controller includes
a transmitter receiving the data signal and the clock signal, generating a modulation signal by inserting the clock signal to the data signal with a predetermined interval, converting the modulation signal into the differential pair image signal having the different level respectively corresponding to the data signal period and the clock signal period.

7. The driving device of claim 6, wherein
the transmitter comprises:
a serial unit receiving the data signal and aligning it in series;
a multiplex unit inserting the clock signal to the arranged data signal in series to generate the modulation signal;
an image signal generator receiving the modulation signal, converting the modulation signal into the differential pair image signal having the different level respectively corresponding to the data signal period and the clock signal period, and converting the differential pair image signal of the data signal period during the initial emphasis period; and
a controller receiving the information for the data signal, the clock signal, controlling the position of inserting the clock signal to the data signal according to the predetermined interval, and controlling an amplification degree according to the data signal period and the clock signal period of the differential pair image signal.

8. The driving device of claim 1, further comprising
a data driver receiving the differential pair image signal, dividing the data signal and the clock signal from the differential pair image signal, and sampling the data signal by using the clock signal to generate a data voltage.

9. The driving device of claim 8, wherein
the differential pair image signal further includes a data control signal for controlling the operation of the data driver.

10. The driving device of claim 8, wherein
the data driver recovers the clock signal with a frequency corresponding to a frequency of the data signal, samples the data signal by using the recovered clock signal to generate a digital data signal, and generates a data voltage corresponding to the digital data signal.

11. A driving method for a display device displaying images according to an input image signal and an input control signal, comprising:
modulating a data signal corresponding to the input image signal by inserting a clock signal generated according to the input control signal to the data signal with a predetermined interval;
converting the modulated signal into a differential pair image signal by discriminating a different level according to a data signal period corresponding to the data signal and a clock signal period corresponding to the clock signal,
wherein
during the data signal period, a voltage difference between the differential pair image signal is substantially the same as a voltage difference between a high level voltage and a low level voltage, and
during the clock signal period, a voltage difference between the differential pair image signal is substantially the same as a voltage difference between the high level voltage and a reference voltage.

12. The driving method of claim 11, further comprising
generating a data voltage corresponding to the input image signal by receiving the differential pair image signal,
wherein the generating of the data voltage includes
recovering the clock signal with a frequency corresponding to the frequency of the data signal,
generating a digital data signal by sampling the data signal by using the recovered clock signal, and
selecting a data voltage corresponding to the digital data signal among a plurality of gray voltages.

13. The driving method of claim 12, wherein
the modulating is executed by further including a data control signal to the data signal and clock signal, and the data control signal is a signal for controlling the generating of the data voltage.

14. The driving method of claim 13, wherein
the generating of the data voltage further includes dividing the data control signal from the differential pair image signal.

15. A display device comprising:
a plurality of data lines;
a data driver which applies data voltages to the plurality of data lines; and
a signal controller generating a data signal according to the input image signal, generating a clock signal according to the input control signal, generating a differential pair image signal including a positive signal and a negative signal by modulating the clock signal to the data signal, outputting the differential pair image signal to the data driver, and respectively converting the differential pair image signal of the data signal period and the clock signal period into different levels,
wherein
during the data signal period, a voltage difference between the positive signal and the negative signal is substantially same as a voltage difference between a high level voltage and a low level voltage, and
during the clock signal period, a voltage difference between the positive signal and the negative signal is substantially same as a voltage difference between the high level voltage and a reference voltage.

16. The display device of claim 15, wherein the high level voltage is higher than the low level voltage and the reference voltage is lower than low level voltage.

17. The display device of claim 16, wherein
the differential pair image signal represents the digital data “1” when the difference between the positive signal and the negative signal is positive, and
the differential pair image signal represents the digital data “0” when the difference between the positive signal and the negative signal is negative.

18. The display device of claim 15, wherein
the signal controller includes
an transmitter receiving the data signal and the clock signal, generating a modulation signal by inserting the clock signal to the data signal with a predetermined interval, converting the modulation signal into the differential pair image signal having the different level respectively corresponding to the data signal period and the clock signal period.

19. The display device of claim 18, wherein
the transmitter comprises:
a serial unit receiving the data signal and aligning it in series;
a multiplex unit inserting the clock signal to the arranged data signal in series to generate the modulation signal;
an image signal generator receiving the modulation signal, converting the modulation signal into the differential pair image signal having the different level respectively corresponding to the data signal period and the clock signal period, and converting the differential pair image signal of the data signal period during the initial emphasis period; and
a controller receiving the information for the data signal, the clock signal, controlling the position of inserting the clock signal to the data signal according to the predetermined interval, and controlling an amplification degree according to the data signal period and the clock signal period of the differential pair image signal.

20. The display device of claim 15, wherein
the data driver recovers the clock signal with a frequency corresponding to a frequency of the data signal, samples the data signal by using the recovered clock signal to generate a digital data signal, and generates a data voltage corresponding to the digital data signal.
